(19) United States
(12) Patent Application Publication
(10) Pub. No.: US 2026/0290697 A1
(43) Pub. Date: Sep. 24, 2026

(54) MULTILAYER ELECTRONIC COMPONENT

(71) Applicant: SAMSUNG ELECTRO-MECHANICS CO., LTD., Suwon-si (KR)

(72) Inventor: Su Ho JUNG, Suwon-si (KR)

(73) Assignee: SAMSUNG ELECTRO-MECHANICS CO., LTD., Suwon-si (KR)

(21) Appl. No.: 19/550,547

(22) Filed: Feb. 26, 2026

(30) Foreign Application Priority Data
Mar. 20, 2025 (KR) 10-2025-0036122

(51) Int. Cl. H01G 4/232; H01G 4/248; H01G 4/30

(52) U.S. Cl. CPC H01G 4/2325; H01G 4/248; H01G 4/30

(57) ABSTRACT

A multilayer electronic component may include: a body including a stack body in which a dielectric layer and an internal electrode are stacked in a first direction, and a cover portion disposed on both surfaces of the stack body opposing each other in the first direction and having a corner having a rounded shape; and an external electrode. The external electrode may include: a first electrode layer in contact with both surfaces of the stack body opposing each other in a second direction, and having an end having a rounded shape; a second electrode layer disposed on the first electrode layer; and a plating layer disposed on the second electrode layer. T2<R2<1.2*T2 may satisfied, where R2 is a radius of curvature of the end of the first electrode layer, and T2 is an average thickness of the first electrode layer in the second direction.

### CROSS-REFERENCE TO RELATED APPLICATION(S)

This application claims benefit of priority to Korean Patent Application No. 10-2025-0036122 filed on Mar. 20, 2025, in the Korean Intellectual Property Office, the disclosure of which is incorporated herein by reference in its entirety.

### TECHNICAL FIELD

The present disclosure relates to a multilayer electronic component.

A Multilayer Ceramic Capacitor (MLCC), a multilayer electronic component, is a chip-shaped capacitor mounted on the printed circuit boards of various electronic devices, including video display devices such as liquid crystal displays (LCD) and plasma display panels (PDP), computers, smartphones, and mobile phones, as well as onboard chargers (OBC) and DC-DC converters for electric vehicles to charge or discharge electricity.

When thicknesses of a cover portion and a margin portion are thinned according to the requirements for miniaturization of the MLCC, the brittleness of a body may increase to increase the likelihood of chipping defects. Furthermore, as external electrodes are thinner, breakage thereof at a corner external electrode may occur, or the density of the external electrodes may decrease, which may result in a decrease in the ability to prevent the infiltration of external moisture and a plating solution.

Conventional methods to resolve these issues include polishing corners body to impart a curvature. However, as the corner of the body is excessively polished, the structural vulnerability of the body corners may be increased and the risk of exposure of the internal electrodes may increase.

Accordingly, there is a need for structural improvements to the external electrodes that may minimize the degree of polishing the corners of the body while mitigating chipping defects and edge breakage of the corners of the external electrode.

### SUMMARY

An aspect of the present disclosure is to alleviate a chipping defect that may occur as a curvature of a corner of a body increases.

An aspect of the present disclosure is to alleviate a problem in which, as a curvature of a corner of the body increases, a thickness of a corner of an external electrode decreases or a disconnection of the corner thereof may occur to result in reduction of the moisture resistance reliability of a multilayer electronic component.

However, the aspects of the present disclosure are not limited to the above-described content, and will be more readily understood in a process of describing specific example embodiments of the present disclosure.

A multilayer electronic component according to an example embodiment of the present disclosure may include: a body including a stack body including a dielectric layer and an internal electrode stacked in a first direction, and a cover portion disposed on both surfaces of the stack body opposing each other in the first direction, the cover portion having a corner having a rounded shape; and an external electrode disposed on the body and connected to the internal electrode, and the external electrode may include: a first electrode layer in contact with both surfaces of the stack body opposing each other in a second direction that is perpendicular to the first direction, the first electrode layer having an end having a rounded shape; a second electrode layer disposed on the first electrode layer; and a plating layer disposed on the second electrode layer, and when a radius of curvature of the end of the first electrode layer is defined as R2 and an average thickness of the first electrode layer in the second direction is defined as T2, T2<R2<1.2*T2 may be satisfied.

One of the various effects of the present disclosure is to alleviate chipping defects in a multilayer electronic component by allowing a corner of a cover portion and an end of an electrode layer to respectively have a rounded shape and organically controlling a thickness of the cover portion and a radius of curvature of the corner of the cover portion.

One of the various effects of the present disclosure is to alleviate chipping defects in a multilayer electronic component by allowing a corner of a cover portion and an end of an electrode layer to respectively have a rounded shape and organically controlling a thickness of the electrode layer and a radius of curvature of an end of the electrode layer.

One of the various effects of the present disclosure is to alleviate chipping defects in a multilayer electronic component by allowing a rounded shape of an end of an electrode layer and a rounded shape of a corner of a cover portion to function as a single rounded shape.

One of the various effects of the present disclosure is to improve the moisture resistance reliability by allowing a rounded shape of an end of an electrode layer and a rounded shape of a corner of a cover portion to function as a single rounded shape and enabling a corner of an external electrode to form a sufficient thickness.

However, the aspects of the present disclosure are not limited to the above-described contents, and may be more easily understood in the process of describing specific embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an example embodiment of the present disclosure;

FIG. 2 is a schematic partial view taken along line I-I′ of FIG. 1;

FIG. 3 is a schematic cross-sectional view taken along line II-II′ of FIG. 1;

FIG. 4 is an exploded perspective view schematically illustrating a body in which a dielectric layer, an internal electrode, and a cover part are stacked according to an example embodiment;

FIG. 5 is an enlarged view of a region K of FIG. 2;

FIG. 6 is a schematic diagram illustrating a method of determining a point P1 of FIG. 5; and

FIG. 7 is a schematic diagram illustrating a method of determining a point P4 of FIG. 5.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to better explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

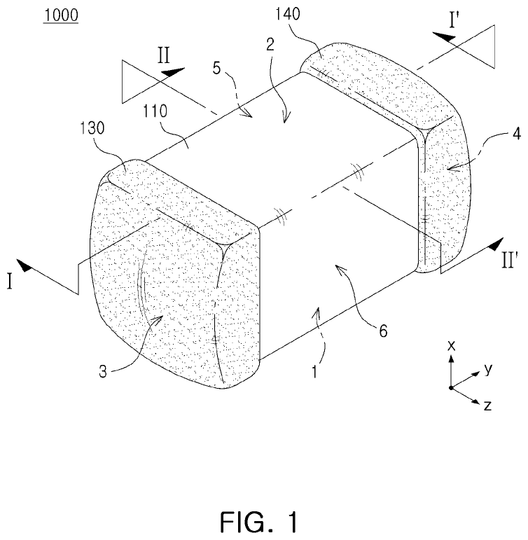

FIG. 1 is a perspective view schematically illustrating a multilayer electronic component according to an example embodiment of the present disclosure.

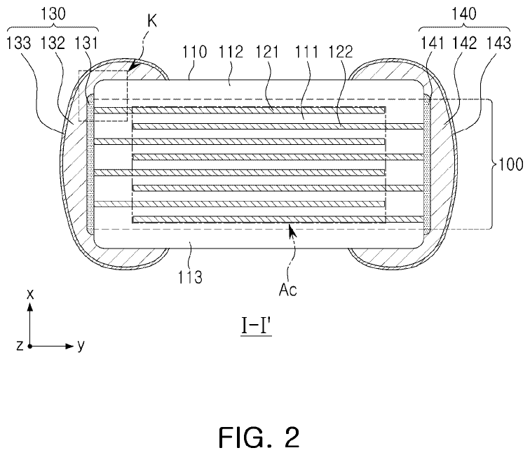

FIG. 2 is a schematic partial view taken along line I-I′ of FIG. 1.

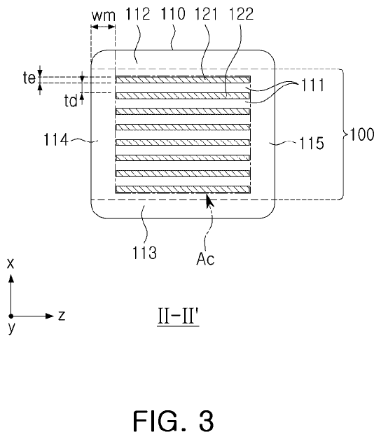

FIG. 3 is a schematic cross-sectional view taken along line II-II′ of FIG. 1.

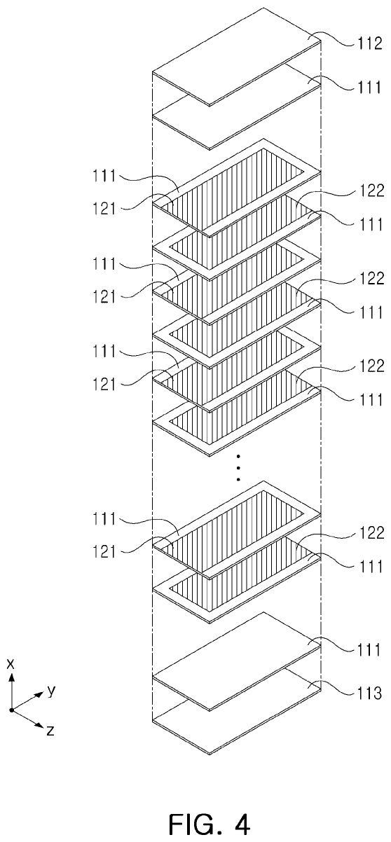

FIG. 4 is an exploded perspective view schematically illustrating a body in which a dielectric layer, an internal electrode, and a cover part are stacked according to an example embodiment.

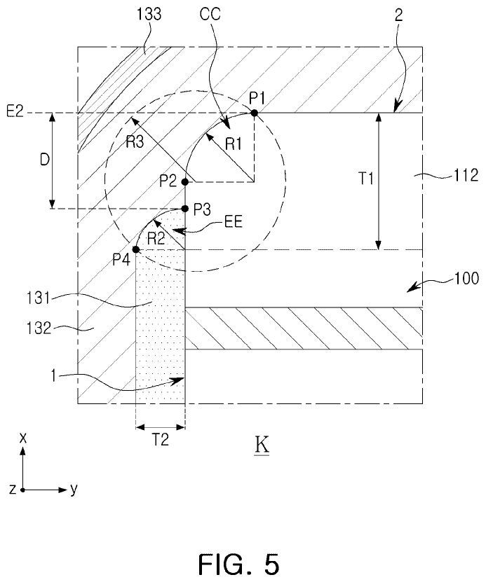

FIG. 5 is an enlarged view of a region K of FIG. 2.

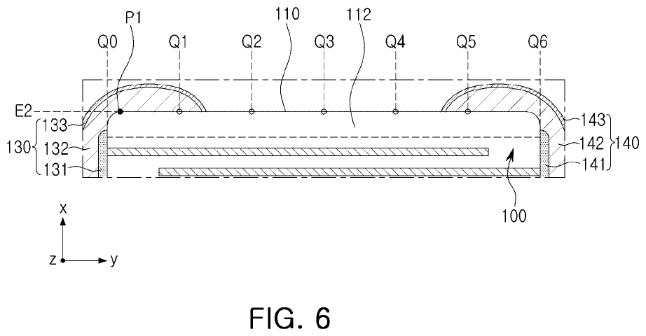

FIG. 6 is a schematic diagram illustrating a method of determining a point P1 of FIG. 6.

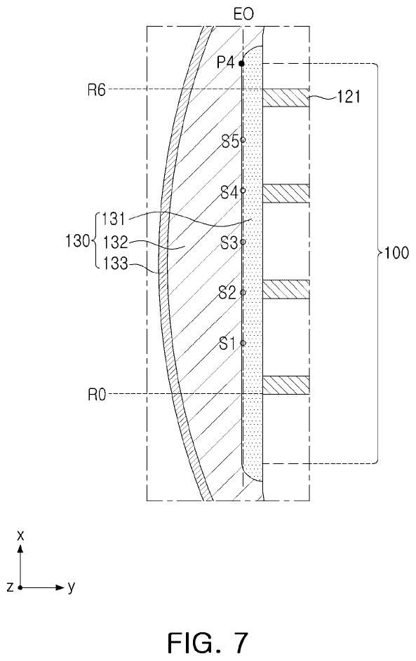

FIG. 7 is a schematic diagram illustrating a method of determining a point P4 of FIG. 5.

In addition, in the drawing, an X-direction (e.g., first direction) may mean a thickness direction, a Y-direction (e.g., second direction) may mean a longitudinal direction, and a Z-direction (e.g., third direction) may mean a width direction, and a stacking direction of internal electrodes or dielectric layers may be a thickness direction or a width direction.

Hereinafter, a multilayer electronic component 1000 according to an example embodiment of the present disclosure and various example embodiments thereof will be described in detail with reference to FIGS. 1 to 7.

A multilayer electronic component 1000 according to an example embodiment of the present disclosure may include a body 110 including a stack body 100 in which a dielectric layer 111 and internal electrodes 121 and 122 are stacked in a first direction, and including cover portions 112 and 113 disposed on both surfaces of the stack body 100 opposing each other in the first direction and having a corner CC having a rounded shape, and external electrodes 130 and 140 disposed on the body 110 and connected to the internal electrodes 121 and 122, and the external electrodes 130 and 140 may include first electrode layers 131 and 141 in contact with both surfaces of the stack body 100 opposing each other in a second direction, perpendicular to the first direction, and having an end EE having a rounded shape, second electrode layers 132 and 142 disposed on the first electrode layers 131 and 141, and plating layers 133 and 143 disposed on the second electrode layers 132 and 142, and when a radius of curvature of the end EE of the first electrode layers 131 and 141 is defined as R2 and an average thickness of the first electrode layers 131 and 141 in the second direction is defined as T2, T2<R2<1.2*T2 may be satisfied.

While there are no specific limitations on the specific shape of the body 110, as illustrated, the body 110 may be formed in a hexahedral shape or a similar shape. Due to shrinkage of ceramic powder particles included in the body 110 during a sintering process, the body 110 may not be a perfectly geometrical hexahedral shape, but may have a substantially hexahedral shape.

Referring to FIG. 1, the body 110 may include a first surface 1 and a second surface 2 opposing each other in the first direction, a third surface 3 and a fourth surface 4 connected to the first surface 1 and the second surface 2 and opposing each other in the second direction, and a fifth surface 5 and a sixth surface 6 connected to the first through fourth surfaces 1, 2, 3 and 4 and opposing each other in the third direction.

Referring to FIGS. 2 and 3, the body 110 may include the stack body 100 in which the internal electrodes 121 and 122 and the dielectric layer 111 are stacked in the first direction. The stack body 100 may include a capacitance formation portion Ac, which is a region in which a first internal electrode 121 and a second internal electrode 122 overlap each other in the first direction, and a region excluding the capacitance formation portion Ac.

The dielectric layer 111 forming the stack body 100 is in a sintered state, and boundaries between adjacent dielectric layers 111 may be integrated to be difficult to identify without using a scanning electron microscope (SEM).

The raw material included in the dielectric layer 111 is not particularly limited as long as the material may achieve sufficient electrostatic capacity. For example, barium titanate-based materials, lead composite perovskite-based materials, or strontium titanate-based materials may be used as the material. The barium titanate-based material may include BaTiO₃-based ceramic powder particles. Examples of the ceramic powder particles may include BaTiO₃, and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1), which is formed by partially employing calcium (Ca) and zirconium (Zr) in BaTiO₃.

In addition, the raw material included in the dielectric layer 111 may be obtained by adding various ceramic additives, organic solvents, binders, dispersants, or the like, to powder particles such as barium titanate (BaTiO₃), depending on the purpose of the present disclosure.

An average thickness td of the dielectric layer 111 need not be particularly limited. For example, in order to easily achieve the miniaturization and high capacitance of a multilayer electronic component 1000, the average thickness td of the dielectric layer 111 may be 0.35 μm or less. In order to improve the reliability of the multilayer electronic component 1000 under high temperature and high voltage, the average thickness td of the dielectric layer 111 may be 1 μm or greater.

The average thickness td of the dielectric layer 111 may refer to an average thickness of one or more first dielectric layers, in the first direction, among the plurality of first dielectric layers.

The average thickness of the dielectric layer 111 in the first direction may be measured by scanning images of first and second directional cross-sections of the multilayer electronic component 1000 using a scanning electron microscope (SEM) at 10,000× magnification. More specifically, the average thickness of the dielectric layer 111 in the first direction may refer to an average value calculated by measuring first directional thicknesses of one dielectric layer 111 at four or more points spaced apart from each other by equal intervals in the second direction in a scanned image. The four or more equally spaced points may be designated by the capacitance formation portion Ac. Furthermore, when the average value is measured by expanding this average value measurement to four or more dielectric layers 111, the average thickness of the dielectric layer 111 in the first direction may be further generalized.

The internal electrodes 121 and 122 may be disposed alternately with the dielectric layer 111 in the first direction, and may include a first internal electrode 121 connected to a first external electrode 130 and a second internal electrode 122 connected to a second external electrode 140.

The first and second internal electrodes 121 and 122 may be electrically isolated from each other by a dielectric layer 111 interposed therebetween.

The material included in the internal electrodes 121 and 122 is not particularly limited, and any material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti) and alloys thereof.

Furthermore, the internal electrodes 121 and 122 may be formed by printing a conductive paste for internal electrodes, including one or more of nickel (Ni), copper (Cu), palladium (Pd), silver (Ag), gold (Au), platinum (Pt), tin (Sn), tungsten (W), titanium (Ti) and alloys thereof, onto a ceramic green sheet. A printing method of the conductive paste for internal electrodes may use a screen printing method or a gravure printing method, and the present disclosure is not limited thereto.

Meanwhile, a thickness the of the internal electrodes 121 and 122 need not be particularly limited.

In order to easily achieve the miniaturization and high capacitance of the multilayer electronic component 1000, the average thickness the of the internal electrodes 121 and 122 may be 0.35 μm or less, and in order to improve the reliability of the multilayer electronic component 1000 under high temperature and high voltage, the average thickness the of the internal electrodes 121 and 122 may be 1 μm or more.

The average thickness the of the internal electrodes 121 and 122 may refer to an average thickness in the first direction of one or more of the plurality of internal electrodes 121 and 122.

The average thickness of the internal electrodes 121 and 122 in the first direction may be measured by scanning images of first and second directional cross-sections of the multilayer electronic component 1000 using a scanning electron microscope (SEM) at 10,000× magnification. More specifically, the average thickness of one internal electrode in the first direction may be an average value obtained by measuring first directional thicknesses of the one interval electrode at four or more points spaced apart from each other by equal intervals in the second direction in the scanned image. The four or more equally spaced points may be designated by the capacitance formation portion Ac. Furthermore, when the average value is measured by expanding this average value measurement to four or more internal electrodes 121 and 122, the average thickness of the internal electrodes 121 and 122 in the first direction may be further generalized.

Referring to FIGS. 2 and 3, the cover portions 112 and 113 may be disposed on both surfaces of the stack body 100 opposing each other in the first direction. The cover portions 112 and 113 do not include internal electrodes 121 and 122 and may include the same dielectric material as the dielectric layer 111, but specific compositions thereof may differ.

Meanwhile, an average thickness T1 of the cover portions 112 and 113 need not be particularly limited. However, in order to easily achieve the miniaturization and high capacitance of the multilayer electronic component, the average thickness T1 of the cover portions 112 and 113 may be 15 μm or less. Here, the average thickness of the cover portions 112 and 113 may refer to an average thickness of each of a first cover portion 112 and a second cover portion 113.

The average thickness T1 of the cover portions 112 and 113 may mean a first directional size, and may be an average value of the first directional sizes of the cover portions 112 and 113 measured at five points spaced apart from each other by equal intervals in an upper portion or a lower portion of the capacitance formation portion Ac.

Referring to FIG. 3, margin portions 114 and 115 may be disposed on both surfaces of the stack body 100 in the third direction.

As illustrated in FIG. 3, the margin portions 114 and 115 may refer to a region between both ends of the first and second internal electrodes 121 and 122 and a boundary surface of the body 110 in a cross-section obtained by cutting the body 110 in a width-thickness (W-T) direction.

The margin portions 114 and 115 may fundamentally serve to prevent damage to the internal electrodes due to physical or chemical stress.

The margin portions 114 and 115 may be formed by applying a conductive paste to a ceramic green sheet, except where the margin portions are to be formed, to form the internal electrodes.

Furthermore, in order to suppress step portions caused by the internal electrodes 121 and 122, the internal electrodes may be stacked and then cut so as to be exposed to the fifth and sixth surfaces 5 and 6 of the body, and then, a single dielectric layer or two or more dielectric layers may be stacked in a widthwise direction on both side surfaces of the capacitance formation portion Ac to form the margin portions 114 and 115.

Meanwhile, a width wm of the margin portions 114 and 115 need not be specifically limited. However, in order to easily achieve the miniaturization and high capacitance of the multilayer electronic component, the average width of the margin portions 114 and 115 may be 15 μm or less.

The average width wm of the margin portions 114 and 115 may refer to an average size of the margin portions 114 and 115 in the third direction, and may be a value obtained by averaging third directional sizes of the margin portions 114 and 115 measured at five points spaced apart from each other by equal intervals on the side surface of the capacitance formation portion Ac.

The external electrodes 130 and 140 are disposed on the body 110.

The external electrodes 130 and 140 are disposed on the third surface 3 and the fourth surface 4, which are surfaces opposing each other in the second direction, perpendicular to the first direction of the body 110, and may be connected to the internal electrodes 121 and 122. Specifically, the first external electrode 130 may be disposed on the third surface 3, which is one surface oriented in the second direction, perpendicular to the first direction of the body 110, and connected to the first internal electrode 121. The second external electrode 140 may be disposed on the fourth surface 4, which is the other surface oriented in the second direction, perpendicular to the first direction of the body 110, and connected to the second internal electrode 122.

While this example embodiment describes a structure in which the multilayer electronic component 1000 has two external electrodes 130 and 140, the number and shape of the external electrodes 130 and 140 may vary depending on the shape of the internal electrodes 121 and 122 or other purposes.

Referring to FIG. 2, the external electrodes 130 and 140 may include first electrode layers 131 and 141 in contact with both surfaces of the stack body 100 opposing each other in the second direction, perpendicular to the first direction and having an end having a rounded shape, second electrode layers 132 and 142 disposed on the first electrode layers 131 and 141, and plating layers 133 and 143 disposed on the second electrode layers 132 and 142.

The first electrode layers 131 and 141 are electrode layers that directly contact the stack body 100 and may serve to secure electrical connectivity having the internal electrodes 121 and 122. Accordingly, the first electrode layers 131 and 141 may directly contact second directional ends of at least some of the plurality of internal electrodes 121 and 122.

The first electrode layers 131 and 141 may be one of a sintered electrode including a conductive metal and glass, a plating layer including a conductive metal, a conductive resin layer including a conductive metal and a resin, a heavily (highly) doped semiconductor layer including a high concentration of impurities, or a conductive polymer layer including a conductive metal-conductive polymer.

In an example embodiment, when the first electrode layers 131 and 141 include the conductive metal, the conductive metal may refer to a monoatomic metal such as Cu, Ni, Ag, Au, Pd or Pt, or alloys including two or more of elements thereof.

In an example embodiment, when the first electrode layers 131 and 141 include the conductive polymer, the conductive polymer may be one or more of polyacetylene (PA), polypyrrole (PPy), polyaniline (PANI), poly(3,4-ethylenedioxythiophene) (PEDOT), and polythiophene (PT).

A method of forming the first electrode layers 131 and 141 is not particularly limited. However, plating methods such as electroplating and electroless plating, or deposition methods such as CVD and PVD, may be used to form a thin and dense electrode layer, and the first electrode layers 131 and 141 may also be formed by applying a paste including a conductive metal and a resin or a conductive polymer, or by applying a paste including a conductive metal and glass.

Meanwhile, when forming the first electrode layers 131 and 141 using a plating method, it may be possible to plate Ni, which facilitates the growth of the plating layer, from the ends of the internal electrodes 121 and 122. That is, in an example embodiment, the first electrode layers 131 and 141 may include Ni, and Ni may be included in a content of 60 at % or more relative to the total elements excluding oxygen included in the first electrode layers 131 and 141. The content of Ni may be determined by energy dispersive X-ray spectroscopy (EDX). Other methods and/or tools appreciated by one of ordinary skill in the art, even if not described in the present disclosure, may also be used.

The second electrode layers 132 and 142 may be disposed on the first electrode layers 131 and 141. The composition of the second electrode layers 132 and 142 is not particularly limited, as long as the second electrode layers 132 and 142 cover the first electrode layers 131 and 141 and ensures electrical conductivity of the external electrodes 130 and 140.

However, in an example embodiment, the second electrode layers 132 and 142 may include a conductive metal and glass, thereby ensuring adhesion between the external electrodes 130 and 140 and the body 110.

In an example embodiment, the second electrode layers 132 and 142 may be disposed on the first electrode layers 131 and 141 and may be disposed to cover the corners CC of the cover portions 112 and 113. Accordingly, the adhesion between the external electrodes 130 and 140 and the body 110 may be further enhanced, and the moisture resistance reliability of the multilayer electronic component 1000 may be further enhanced.

The plating layers 133 and 143 may serve to improve the sealing properties or mounting characteristics of the multilayer electronic component 1000. The type of plating layers 133 and 143 is not particularly limited, and may be a plating layer including one or more of Ni, Sn, Pd, or alloys thereof, and may be comprised of a plurality of layers.

For more specific examples of the plating layers 133 and 143, the plating layers 133 and 143 may include a Ni plating layer including Ni or a Sn plating layer including Sn, and may have a form in which a plating layer including Ni and a plating layer including Sn may be sequentially formed on the second electrode layers 132 and 142, or may have a form in which a plating layer including Sn, a plating layer including Ni, and a plating layer including Sn may be sequentially formed. Furthermore, the plating layer may include a plurality of Ni plating layers and/or a plurality of Sn plating layers.

When the cover portion and the margin portion are formed thinly to miniaturize the multilayer electronic component, the brittleness of the body may increase, resulting in damage to the exterior and internal microstructure of the multilayer electronic component.

One example of a conventional approach to addressing these issues is a method of polishing corners of the body to impart a curvature thereto. However, excessive polishing of the corners thereof may increase the structural vulnerability of the corners and may increase the risk of internal electrodes being exposed. Furthermore, as the curvature of the corners of the body increases (the radius of curvature decreases), the external electrodes 130 and 140 disposed on the body may be formed thinly or may be disconnected at the corners of the body.

On the other hand, in an example embodiment of the present disclosure, the corners of the cover portions 112 and 113 and the ends EE of the first electrode layers 131 and 142 are each formed to have a rounded shape, and a correlation between two or more of the average thickness T1 of the cover portion, a radius of curvature R1 of the corners CC of the cover portions 112 and 113, an average thickness T2 of the first electrode layers 131 and 141, a radius of curvature R2 of the ends EE of the first electrode layers 131 and 141, and a first directional distance D from an end P3 of the first electrode layers 131 and 141 to an outermost point P1 of the corners CC of the cover portions 112 and 113 in the first direction may be controlled, so that the risk of increased structural vulnerability of the corners CC of the cover portions 112 and 113 among the corners of the body 110 may be reduced, which may alleviate problems in which excessive curvature (reduction in radius of curvature) at the corners CC is formed to locally thinly form or disconnect the external electrodes 130 and 140.

Hereinafter, with reference to FIG. 5, the correlation between two or more of the average thickness T1 of the cover portion, the radius of curvature R1 of the corners CC of the cover portions 112 and 113, the average thickness T2 of the first electrode layers 131 and 141, the radius of curvature R2 of the ends EE of the first electrode layers 131 and 141, and the first directional distance D from the end P3 of the first electrode layers 131 and 141 to the outermost point P1 of the corners CC of the cover portions 112 and 113 in the first direction will be described in detail. Hereinafter, the description will be based on the first electrode layer 131 of the first external electrode 130 and the cover portion 112 disposed on an upper surface of the stack body 100. However, the features described below may also be applied to the first electrode layer 141 and the cover portion 113 of the second external electrode 140.

Referring to FIG. 5, the first electrode layer 131 may have the end EE, and may refer to a first directional cross-section (end surface) of the first electrode layer 131 having a rounded shape. Meanwhile, in FIG. 5, the radius of curvature of the end EE of the first electrode layer 131 is indicated as R2. Meanwhile, referring also to FIG. 5, the cover portion 112 may have the corner CC, and may refer to a corner connecting the second surface 2 and the first surface 1 of the body 110. The end EE of the first electrode layer 131 and the corner CC of the cover portion 112 may be formed into a rounded shape by performing a separate polishing process after forming the first electrode layer 131 on the stack body 100.

The type of polishing process for the end EE of the first electrode layer 131 and the corner CC of the cover portion 112 is not particularly limited, but a rounded shape may be formed at the end EE of the first electrode layer 131 and the corner CC of the cover portion 112 through dry polishing or wet polishing.

Meanwhile, the method of forming R1 and R2 differently is not particularly limited, but the end EE of the first electrode layer 131 and the corner CC of the cover portion 112 may exhibit differences in hardness depending on materials thereof, and consequently, even under the same external force, different radii of curvature may be formed. Additionally, in the case of the cover portion 112, since the cover portion 112 undergoes polishing in a green chip state before sintering, and may undergo additional polishing after the first electrode layer 131 is formed after sintering, there may be differences in values of R1 and R2.

In an example embodiment of the present disclosure, since each of the corners CC of the cover portions 112 and 113 and the ends EE of the first electrode layers 131 and 141 has a rounded shape, the rounded shape of the corners CC of the cover portions 112 and 113 and the rounded shape of the ends EE of the first electrode layers 131 and 141 may be combined to form a new virtual rounded shape. A radius of curvature R3 of the new rounded shape may has a larger value than those of R1 and R2 due to the combination of R1 and R2. This may alleviate the problem of chipping defects in the multilayer electronic component 1000 and the problem in which the thickness of the external electrodes 130 and 140 is locally reduced or disconnected due to the large curvature (small radius of curvature) of the corners of the body 110.

Meanwhile, in an example embodiment of the present disclosure, the radius of curvature R2 of the end EE of the first electrode layers 131 and 141 and the average thickness T2 of the first electrode layers 131 and 141 in the second direction may satisfy T2<R2<1.2*T2. If R2 is less than T2, it may be difficult to achieve a sufficient curvature radius enhancement effect. If R2 is greater than 1.2*T2, the first directional distance D between the end P3 of the first electrode layers 131 and 141 and the outermost point of the corner CC of the cover portion 112 in the first direction may be excessively increased to result in reduction of the effect of the present disclosure in which the rounded shape of the corner CC of the cover portions 112 and 113 and the rounded shape of the end EE of the first electrode layers 131 and 141 are combined to form a new virtual rounded shape.

In an example embodiment, the radius of curvature R1 of the corner CC of the cover portions 112 and 113 and the average thickness T1 of the cover portions 112 and 113 in the first direction may satisfy 0.3*T1<R1<0.5*T1. When R1 is 0.3*T1 or less, the excessive curvature of the cover portions 112 and 113 may be formed to increase the vulnerability of the inner corners CC, and the distance between the first directional end P3 of the first electrode layers 131 and 141 and an outermost point P2 of the corner CC of the cover portions 112 and 113 in the second direction may be increased to result in reduction of the effect of the present disclosure due to the new radius of curvature R3 formed by the combination of R1 and R2. When R1 is 0.5*T1 or more, the radius of curvature may be large to result in reduction of the effect of the present disclosure in which the rounded shape of the corner CC of the cover portions 112 and 113 and the rounded shape of the end EE of the first electrode layers 131 and 141 are combined to form a new virtual rounded shape.

In an example embodiment, the radius of curvature R1 of the corner CC of the cover portions 112 and 113 and the average thickness T1 in the first direction of the cover portions 112 and 113 may satisfy 0.6*T1<R1+R2<1.1*T1. When R1+R2 is 0.6*T1 or less, the effect of suppressing chipping defects in the multilayer electronic component 1000 may be reduced. When R1+R2 is 1.1*T1 or more, the rounded shape of the corners CC of the cover portions 112 and 113 and the rounded shape of the ends EE of the first electrode layers 131 and 141 may each act as an overall rounded shape, rather than the rounded shape of the corners CC of the cover portions 112 and 113 and the rounded shape of the ends EE of the first electrode layers 131 and 141 being combined to form a new virtual rounded shape.

In an example embodiment, the average thickness T2 of the first electrode layers 131 and 141 in the second direction may satisfy 2 μm≤T2≤5 μm. If T2 is less than 2 μm, the effect of suppressing chipping defects in the multilayer electronic component 1000 and the effect of suppressing disconnection of the external electrodes 130 and 140 may be reduced. If T2 exceeds 5 μm, the external electrodes 130 and 140 occupy an excessive proportion of the entire multilayer electronic component 1000, and thus, the capacitance per unit volume of the multilayer electronic component 1000 may be reduced.

In an example embodiment, the radius of curvature R1 of the corner of the cover portion, the average thickness T1 of the cover portion in the first direction, and the average thickness T2 of the first electrode layers 131 and 141 in the second direction may satisfy R1≤T1/2 and T2<T1/2. If R1 exceeds T1/2 or T2 exceeds T1/2, the effect of suppressing chipping defects according to the present disclosure may be reduced.

In an example embodiment, the radius of curvature R1 of the corner of the cover portion, and the first directional distance D between the end of the first electrode layer and the outermost point of the corner of the cover portion in the first direction may satisfy R1<D≤1.5*R1. If D is less than R1 or exceeds 1.5*R1, the rounded shape of the corners CC of the cover portions 112 and 113 and the rounded shape of the ends EE of the first electrode layers 131 and 141 may be excessively close or may not sufficiently close to result in reduction of the effect of the present disclosure in which the rounded shapes are combined to form a new virtual rounded shape.

In an example embodiment, the combination of the rounded shape of the corners CC of the cover portions 112 and 113 and the rounded shape of the ends EE of the first electrode layers 131 and 141 to form a new virtual rounded shape may mean that, when a radius of a virtual circle passing through the ends P3 of the first electrode layers 131 and 141 and an outermost point P1 of the corners CC of the cover portions 112 and 113 in the first direction is defined as R3, R1<R3 and R2<R3 are satisfied.

In an example embodiment, the first electrode layers 131 and 141 may be in contact with the stack body 100, but may not be disposed on the first surface 1 and second surface 2 of the body 110, and may be disposed so as not to be disposed beyond the corners CC of the cover portions 112 and 113. When the first electrode layers 131 and 141 are disposed on the corners CC of the cover portions 112 and 113, or are disposed beyond the corners CC of the cover portions 112 and 113 and on the first surface 1 and second surface 2 of the body 110, the effect of the present disclosure of mitigating chipping defects in the multilayer electronic component 1000 may be somewhat insufficient.

Meanwhile, in an example embodiment, the positioning of the first electrode layers 131 and 141 so as not to be disposed beyond the corner CC of the cover portions 112 and 113 may mean that the end EE of the first electrode layers 131 and 141 is spaced apart from the corner CC of the cover portions 112 and 113, and more specifically, the positioning thereof may mean that the first directional end P3 of the first electrode layers 131 and 141 is spaced apart from the outermost point P2 of the corner CC of the cover portions 112 and 113 in the second direction.

Meanwhile, R1, R2, R3, D, T1, and T2 according to an example embodiment may be measured by observing the first and second directional cross-sections of the multilayer electronic component 1000 polished to a ½ point in the third direction, using optical equipment such as an optical microscope (OM) or a scanning electron microscope (SEM). Other methods and/or tools appreciated by one of ordinary skill in the art, even if not described in the present disclosure, may also be used. In this application, R1 and R2 may be measured in a partially enlarged region of one corner of the body 110 or the cover portions 112 and 113, and may be preferably a region in which the first directional ends of the first electrode layers 131 and 141 may be observed simultaneously.

Meanwhile, the average thickness T1 of the cover portions 112 and 113 may refer to the average thickness of the cover portions 112 and 113 in the first direction. The average thickness of the cover portions 112 and 113 in the first direction may be measured by scanning images of the first and second directional cross-sections of the body 110 using a scanning electron microscope (SEM) at 10,000× magnification. More specifically, the average thickness may be an average value calculated by measuring the first directional thicknesses at five or more points (Q1, Q2, Q3, Q4, Q5, and the like) spaced apart from each other by equal intervals in the second direction in the image obtained by scanning one cover portion 112, as illustrated in FIG. 6.

Meanwhile, the average thickness T2 of the first electrode layers 131 and 141 may refer to an average thickness of the first electrode layers 131 and 141 in the second direction. The average thickness of the cover portions 112 and 113 in the first direction may be measured by scanning images of the first and second directional cross-sections of the body 110 using the scanning electron microscope (SEM) at 10,000× magnification. More specifically, the average thickness may be an average value calculated by measuring second directional thicknesses at five or more points (S1, S2, S3, S4, S5, and the like) spaced apart from each other by equal intervals in the first direction in a region between a straight line R6 extending from an uppermost point of the internal electrode disposed at an uppermost end in the first direction, among the plurality of first internal electrodes 121, and a straight line R0 extending from a lowermost point of the internal electrode disposed at a lowermost end in the first direction, in the image obtained by scanning one first electrode layer 131 or 141, as illustrated in FIG. 6.

### Example

Table 1 below measures and evaluates chipping defect rates, thicknesses of corners of an external electrode, and moisture resistance reliability of multilayer electronic component samples according to variations in T1, T2, T1, T2, T3 and D. For each test number, the dielectric layer, the internal electrode, the cover portion and the margin portion were formed using the same materials, Ni plating was performed on the stack body to form the first electrode layer, and a conductive paste including Cu and glass was applied to form the second electrode layer, followed by the formation of Ni and Sn plating layers. In order to vary T1, T2, T1, T2, T3 and D for each test number, dry polishing was performed on the corner of the cover portion and the end of the first electrode layer before forming the second electrode layer, and a separate dry polishing was performed in the green chip state before forming the first electrode layer.

The chipping defect rates were determined from the number of defective samples in which chipping was observed in the cover portion and the margin portion in 2,000 samples per test number.

The thickness of the corner of the external electrode was measured in the thinnest portion of the corner region of the external electrode in the first (X-direction) and second (Y-direction) directional cross-section polished to a ½ point of the multilayer electronic component in the third direction. The thickness of the corner of the external electrode was calculated by taking a total of 20 samples from both the first and second external electrodes of 10 multilayer electronic components and calculating an average value thereof.

The humidity reliability evaluation was conducted on 400 samples for each test number under the conditions below, and when one or more samples showed an insulation resistance value of 10⁵Ω or less, the test result was evaluated to be NG.
(Humidity reliability evaluation conditions): Temperature: 85° C., Relative Humidity: 85%, Applied Voltage: 1 Vr, and Voltage Application Time: 3 hours

TABLE

| | | | | | | | | Thickness | |
|---|---|---|---|---|---|---|---|---|---|
| | | | | | | | | of Corner of | |
| | | | | | | | Chipping | External | Humidity |
| Test | T1 | T2 | R1 | R2 | R3 | D | Defect | Electrode | Reliability |
| Number | (μm) | (μm) | (μm) | (μm) | (μm) | (μm) | (ppm) | (μm) | Evaluation |
| 1 | 10 | 0 | 5.5 | — | — | — | 45000 | 2.3 | NG |
| 2 | 10 | 1 | 4.3 | 0.7 | 17.0 | 9.0 | 43000 | 2.5 | NG |
| 3 | 10 | 3 | 4.3 | 2.9 | 13.2 | 5.8 | 7500 | 4.5 | OK |
| 4 | 10 | 5 | 4.4 | 4.8 | 12.6 | 3.2 | 25000 | 3 | NG |
| 5 | 12 | 3 | 4.3 | 2.9 | 15.1 | 7.7 | 18500 | 3.1 | NG |
| 6 | 12 | 5 | 4.4 | 4.8 | 15.3 | 5.1 | 3500 | 5.2 | OK |
| 7 | 15 | 3 | 4.3 | 2.9 | 21.3 | 9.6 | 40000 | 1.8 | NG |
| 8 | 15 | 5 | 4.4 | 4.8 | 25.0 | 7.7 | 35000 | 2 | NG |

It may be confirmed that in Test No. 1, in which the first electrode layer was not formed, the chipping defect frequency was 45,000 ppm, but in Test No. 2, in which the first electrode layer was formed, the chipping defect frequency decreased to 43,000 ppm. In other words, when each of the ends EE of the first electrode layers 131 and 141 and the corners CC of the cover portions 112 and 113 has a rounded shape, as in an example embodiment of the present disclosure, it may be seen that as a result of forming a virtual curvature R3, the problem of chipping defects occurring in the multilayer electronic component 1000 may be alleviated.

Meanwhile, for Test Nos. 4, 5, 7 and 8, which do not satisfy the condition R1≤D≤1.5*R1 according to an example embodiment, it may be confirmed that because a value of D was either smaller or larger than the above-described range, the virtual curvature R3 was large, but the effect of improving chipping defects was somewhat insufficient, and the moisture resistance reliability may also be confirmed to be NG. On the other hand, for Test Nos. 3 and 5, which satisfy condition R1<D≤1.5*R1 according to an example embodiment, it may be confirmed that the effect of improving chipping defects was excellent, and the moisture resistance reliability was also OK. Therefore, when R1≤D≤1.5*R1 is satisfied, as in an example embodiment, the chipping defect improvement effect and moisture resistance reliability improvement according to the present disclosure may be remarkably improved.

Although the example embodiment of the present disclosure has been described in detail above, the present disclosure is not limited to the above-described embodiments and the accompanying drawings but is defined by the appended claims. Accordingly, those of ordinary skill in the art may make various replacements, modifications, or changes without departing from the scope of the present disclosure defined by the appended claims, and these replacements, modifications, or changes should be construed as being included within the scope of the present disclosure.

In addition, the expression an example embodiment' used in the present disclosure does not mean the same embodiment, and is provided to emphasize and explain different unique characteristics. However, the example embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the terms are merely used to describe a specific embodiment, and are not intended to limit the present disclosure. Singular forms may include plural forms as well unless the context clearly indicates otherwise.

What is claimed is:

1. A multilayer electronic component, comprising:
a body including:
a stack body including a dielectric layer and an internal electrode stacked in a first direction, and
a cover portion disposed on both surfaces of the stack body opposing each other in the first direction, the cover portion having a corner having a rounded shape; and
an external electrode disposed on the body and connected to the internal electrode,
wherein the external electrode includes:
a first electrode layer in contact with both surfaces of the stack body opposing each other in a second direction that is perpendicular to the first direction, the first electrode layer having an end having a rounded shape;
a second electrode layer disposed on the first electrode layer; and
a plating layer disposed on the second electrode layer,
wherein, when a radius of curvature of the end of the first electrode layer is defined as R2 and an average thickness of the first electrode layer in the second direction is defined as T2, T2<R2<1.2*T2 is satisfied.

2. The multilayer electronic component according to claim 1, wherein, when a radius of curvature of the corner of the cover portion is defined as R1 and an average thickness of the cover portion in the first direction is defined as T1, 0.3*T1<R1<0.5*T1 is satisfied.

3. The multilayer electronic component according to claim 1, wherein, when a radius of curvature of the corner of the cover portion is defined as R1 and an average thickness of the cover portion in the first direction is defined as T1, 0.6*T1<R1+R2<1.1*T1 is satisfied.

4. The multilayer electronic component according to claim 1, wherein 2 μm≤T2≤5 μm is satisfied.

5. The multilayer electronic component according to claim 1, wherein, when a radius of curvature of the corner of the cover portion is defined as R1 and an average thickness of the cover portion in the first direction is defined as T1, R1≤T1/2 and T2≤T1/2 is satisfied.

6. The multilayer electronic component according to claim 1, wherein, when a radius of curvature of the corner of the cover portion is defined as R1 and, in the first direction, a distance from the end of the first electrode layer to an outermost point of the corner of the cover portion in the first direction is defined as D, R1≤D≤1.5*R1 is satisfied.

7. The multilayer electronic component according to claim 1, wherein the end of the first electrode layer is spaced apart from the corner of the cover portion.

8. The multilayer electronic component according to claim 1, wherein the first electrode layer includes a conductive metal and a conductive polymer.

9. The multilayer electronic component according to claim 1, wherein the first electrode layer includes Ni, and a content of Ni relative to a total content of elements excluding oxygen included in the first electrode layer is 90 at % or more.

10. The multilayer electronic component according to claim 1, wherein the second electrode layer includes a conductive metal and glass.

11. The multilayer electronic component according to claim 10, wherein the second electrode layer covers the corner of the cover portion.

12. The multilayer electronic component according to claim 1, wherein, when a radius of curvature of the corner of the cover portion is defined as R1, and a radius of a virtual circle passing through the end of the first electrode layer and an outermost point of the corner of the cover portion in the first direction is defined as R3, R1<R3 and R2<R3 are satisfied.

13. The multilayer electronic component according to claim 6, wherein D is a distance in the first direction from (i) a point on the end of the first electrode layer that is nearest to the outermost point of the corner of the cover portion to (ii) the outermost point of the corner of the cover portion.

14. The multilayer electronic component according to claim 12, wherein the virtual circle passes through a point on the end of the first electrode layer that is furthest from the outermost point of the corner of the cover portion.
